(19) United States
(12) Patent Application Publication
(10) Pub. No.: US 2016/0106048 A1
(43) Pub. Date: Apr. 21, 2016

(54) Multi Tier Growing Apparatus

(71) Applicants: Matthew Moghaddam, Newark, NJ (US); Hanni Abukhater, Clifton, NJ (US)

(72) Inventors: Matthew Moghaddam, Newark, NJ (US); Hanni Abukhater, Clifton, NJ (US)

(21) Appl. No.: 14/519,360

(22) Filed: Oct. 21, 2014

(51) Int. Cl. A01G 31/04; A01G 7/04

(52) U.S. Cl. CPC A01G 31/04; A01G 7/045

(57) ABSTRACT

Footprint-optimized systems for hydroponic plant cultivation are disclosed herein.

### CLAIM OF PRIORITY

This filing is related to patent application Ser. No. 13/963,681 filed on Aug. 9, 2013 which is incorporated by reference herein in its entirety.

### BACKGROUND

### Field

In the field of hydroponic plant cultivation, it is often beneficial to arrange growing containers in a manner that minimizes their floor space footprint while maximizing the number of plants and the exposure of those plants to light sources. Consequently, devices are described herein designed towards such an optimization.

### SUMMARY

According to certain embodiments of the present disclosure, a system for hydroponic farming includes two complementary driven conveyors disposed upon opposing sides of a plurality of elongated troughs, wherein the conveyors are arranged in a serpentine loop with multiple vertical peaks having substantially parallel vertical travel paths and the toughs are coupled to and capable of pivoting relative to the conveyors.

According to further embodiments of the present disclosure, there are multiple elongated light sources disposed above one another between and in substantially parallel relation to the troughs.

According to further embodiments of the present disclosure, the troughs have apertures disposed upon the dorsal faces thereof sized and shaped for hydroponically growing plants therein.

According to further embodiments of the present disclosure, the troughs have apertures disposed upon opposing lateral faces thereof sized and shaped for hydroponically growing plants therein.

According to further embodiments of the present disclosure, the troughs have a substantially rectangular cross-section.

According to further embodiments of the present disclosure, the troughs have a substantially annular cross-section having a hollow interior and open ends.

According to further embodiments of the present disclosure, the conveyor is a timing belt.

According to further embodiments of the present disclosure, the conveyor is a chain.

According to further embodiments of the present disclosure, there are two gears at the tops and bottoms of a set of peaks engaged upon the conveyor which are oriented and shaped such that substantially parallel vertical adjacent paths are created for that portion the conveyor's path.

According to further embodiments of the present disclosure, there is a gear disposed at the tops and bottoms of each peak engaged upon the conveyor whose diameter is the approximately the distance between adjacent peaks, thereby creating a substantially parallel travel path for the troughs.

According to further embodiments of the present disclosure, there are electronically readable tags disposed upon either a specific trough or specific plating location on a trough.

According to further embodiments of the present disclosure, the tags are chosen from one of bar codes, rfid, Zigbee, Bluetooth, Bluetooth low energy, distinctive graphics, distinctive electromagnetic signature, or a distinctive radio beacon.

According to further embodiments of the present disclosure, the tag influences at least one of the lighting or nutrient output of the system to either a specific trough or planting location.

According to further embodiments of the present disclosure, there is at least 1 dispensing spout that pours nutrient solution into the interior of the trough

According to further embodiments of the present disclosure, along at least one portion of their travel paths, the troughs are at least partially submerged into a bath of nutrient solution.

According to further embodiments of the present disclosure, the locations at which the opposing ends of the toughs are coupled to the conveyor have a vertical offset, thereby elevating one end of the trough relative to the other and reversing this offset as the trough crosses the apex of a peak.

### BRIEF DESCRIPTION OF THE FIGURES

In the figures, which are not necessarily drawn to scale, like numerals describe substantially similar components throughout the several views. The drawings illustrate generally, by way of example, but not by way of limitation, various embodiments discussed in the claims of the present document.

FIG. 1 shows an isometric view of a multi-peak plant growing apparatus.

FIG. 2 shows a side view of a multi-peak plant growing apparatus.

FIG. 3 shows an isometric view of a growing trough.

### DETAILED DESCRIPTION OF THE FIGURES

Various embodiments of the presently disclosed apparatus will now be described in detail with reference to the drawings, wherein like reference numerals identify similar or identical elements. In the drawings and in the description that follows, the term “proximal,” will refer to the end of a device or system that is closest to the operator, while the term “distal” will refer to the end of the device or system that is farthest from the operator. Similar, anatomical terms of reference such as dorsal, lateral, anterior, and sagittal shall have their accepted meanings in the arts.

Further, because there a numerous, repeating parts in the assembly, only several of each type has been labelled. For instance, given that rollers 1200(a-c) are all substantially similar in shape and appearance, it will be apparent to one having ordinary skill in the mechanical arts that 1200(d) are also understood to be “rollers” as defined within this disclosure even if 1200(d) were not labelled and although the remaining rollers in the figure are not specifically called out.

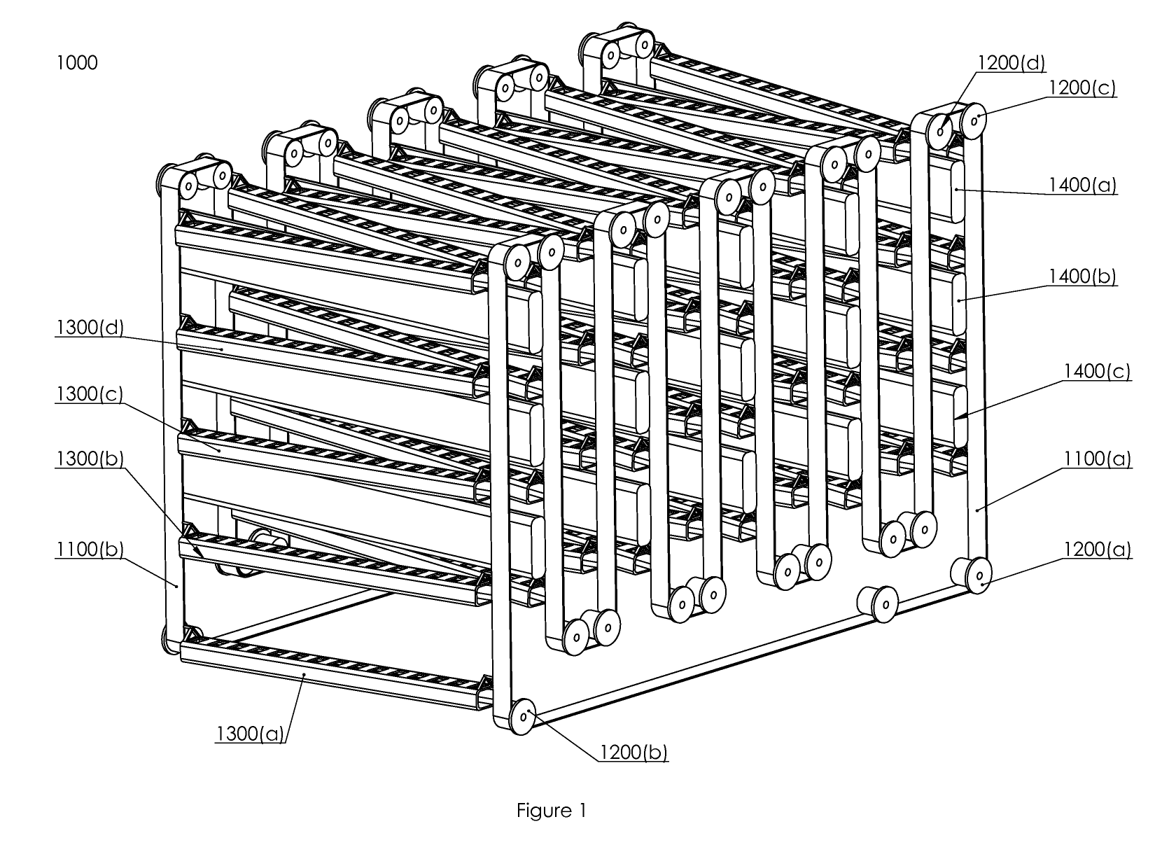

Referring now to FIG. 1, a growing apparatus 1000 is shown having a plurality of rollers 1200(A, B, et. Seq.) coupled to conveyors 1100(a and b). There is a plurality of elongated growing troughs 1300(A, B, et. Seq.) suspended from conveyors 1100(A and B) with lighting fixtures 1400 disposed between the paths of the troughs. Conveyors 1100(A and B) are driven synchronously so that the troughs cycle through the system.

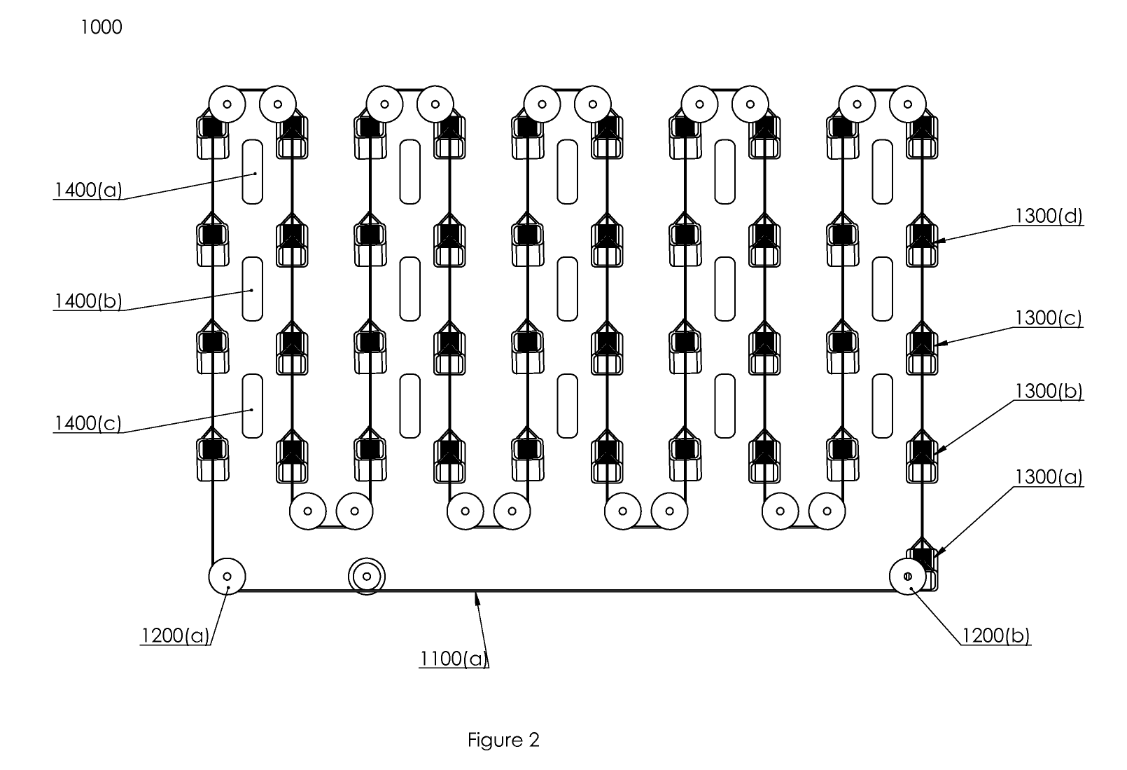

Referring now to FIG. 2, rollers 1200(A, B, et. Seq.) are arranged at approximating alternating corners of a rectangle so as to define a plurality peaks within the system wherein the upward and downward paths of the conveyor are substantially vertical. This arrangement maximizes the width along the entire height of each “peak”, thereby allowing a plurality of elongated light fixtures 1400(a, b, et. Seq.) to be placed along the interior of each path. Light fixtures 1400(a, b, et. Seq.) can be comprised of growing lamp technologies including for instance long channels of LEDs which are spectrum optimized for the growing environment. Although the return path for the conveyor is shown in the figures as running along the bottom of the device, there are further embodiments of the present disclosure, wherein the return path is disposed along the top of the device.

The two conveyors on either side of the device may be comprised of a multi-link drive chain, or alternatively a polymer or polymer reinforced belt. The choice of conveyor technology will of course determine the choice of roller design as well. In the case of a drive chain, an appropriate sprocket and bearing would be selected, while in the case of a belt, the appropriate pulley would be selected.

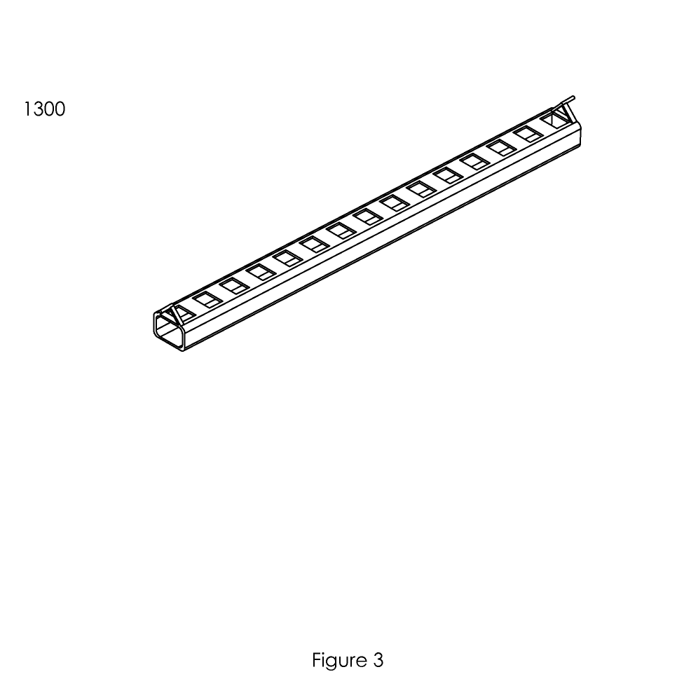

Referring now to FIG. 3, a growing trough 1300 is shown, wherein trough 1300 is an elongated member having a substantially rectangular annular cross-section and open ends on opposing sides thereof. There is a plurality of apertures disposed upon the dorsal face of trough 1300 sized and shaped to accommodate a plant holder, including for instance a hydroponic growing basket which contains a plant as well as growing medium. Although the apertures have been shown here as being disposed upon the dorsal face of the trough, there are further embodiments of the present disclosure wherein there are apertures oriented upon the opposing lateral walls of the device. In such an arrangement, plants can be staggered, thereby significantly reducing crowding and improving access to illumination from the lighting fixtures.

At opposing ends of the growing troughs are coupling pins which are sized and shaped to be fixably engaged upon the conveyors. In the case of a belt conveyor, these may be a crimp or clamp while in the case of a chain conveyor, these may be a clip which connects to and hangs from the links of a chain. Once engaged upon the conveyor, the tough hangs down and is free to swing from the clip, thereby always hanging downward.

Although the conveyors 1100(a and b) are synchronized, the troughs are connected to them at an offset. For instance, in the example shown in FIG. 1, the first end of trough 1300(a) is connected to a point on conveyor 1100(a) which is further along the path of rotation than the point along conveyor 1100(b) is connected to trough 1300(a)'s second end, thereby inducing a slant, which is visible in the figures and reverses direction at the apex of a given peak. Because of the slanted nature of the trough and their open ends, nutrient solution which has not been absorbed by the plants within a trough is free to drip out of the lower end of that trough.

Nutrients and water may be introduced into the system by means of partially submerging the trough into a bath of nutrient solution along a part of its travel, including for instance, at the bottom of one of the peaks. Alternatively, there are further embodiments of the present disclosure wherein there is an outlet which pumps a nutrient rich solution into the interior of a given growing trough as it passes the outlet.

There are further embodiments of the present disclosure, wherein a specific trough or aperture location on a specific trough is marked with a machine readable tag including for instance rfid, barcode, graphical marking, magnetic marking, Bluetooth low energy, Zigbee, or other “tagging” technology known in the arts. As these markings pass a reader, information about the trough, its contents, as well as their needs and state of growth is optionally used to determine the nutrients and lighting delivered to that trough as it passes through the system. This includes for instance tailoring the spectrum and quantity of output to a specific trough or aperture location from a lighting fixture or the quantity and type of nutrient solution delivered.

For the ease of explanation, several elements have been excluded from the figures which are necessary for the operation of the present invention. These include (1) a frame or support member for the rollers and lighting fixtures which is capable of holding each roller fixed in space while consequently supporting the remainder of the assembly, (2) a drive mechanism coupled to the conveyor either directly or via one of the rollers, as the rollers must be synchronously driven, this may be achieved by a live axel, motors on each side of the device, or other methods known in the mechanical arts, and (3) an optional idler mechanism coupled to one of the rollers capable of tensioning the drive mechanism.

What is claimed is:

1. A system for hydroponic farming, the system comprising; two complementary driven conveyors disposed upon opposing sides of a plurality of elongated troughs, wherein the conveyors are arranged in a serpentine loop with multiple vertical peaks having substantially parallel vertical travel paths and the toughs are coupled to and capable of pivoting upon the conveyors.

2. The system of claim 1, wherein there are multiple elongated light sources disposed above one another between and in substantially parallel relation to the troughs.

3. The systems of claim 1, wherein the troughs have apertures disposed upon the dorsal faces thereof sized and shaped for hydroponically growing plants therein.

4. The system of claim 1, wherein the troughs have apertures disposed upon opposing lateral faces thereof sized and shaped for hydroponically growing plants therein.

5. The system of claim 1, wherein the troughs have a substantially rectangular cross-section.

6. The system of claim 1, wherein the troughs have a substantially annular cross-section having a hollow interior and open ends.

7. The system of claim 1, wherein the conveyor is a timing belt.

8. The system of claim 1, wherein the conveyor is a chain.

9. The system of claim 1, wherein there are two gears at the tops and bottoms of a set of peaks oriented and shaped such that substantially parallel vertical adjacent paths are created for the conveyor.

10. The system of claim 1, wherein there is a gear disposed at the tops and bottoms of each peak whose diameter is the approximately the distance between adjacent peaks, thereby creating a substantially parallel travel path for the troughs.

11. The system of claim 1, wherein there are electronically readable tags disposed upon either a specific trough or specific plating location on a trough.

12. The system of claim 11, where the tags are chosen from one of bar codes, rfid, zigbee, Bluetooth, Bluetooth low energy, distinctive graphics, distinctive electromagnetic signature, or a distinctive radio beacon.

13. The system of claim 11, wherein the tag influences at least one of the lighting or nutrient output of the system to either a specific trough or planting location.

14. The system of claim 6, wherein there is at least 1 dispensing spout that pours nutrients into the interior of the trough

15. The system of claim 6, wherein along at least one portion of their travel paths, the troughs are at least partially submerged into a bath of nutrient solution.

16. The system of claim 1, wherein the locations at which the opposing ends of the toughs are coupled to the conveyor have a vertical offset, thereby elevating one end of the trough relative to the other and reversing this offset as the trough crosses the apex of a peak.

17. A system for hydroponic farming, the system comprising; two complementary conveyors disposed upon opposing sides of a plurality of elongated troughs, wherein the conveyors are arranged in a serpentine loop with multiple vertical peaks with substantially parallel vertical travel paths and the toughs are coupled to and capable of pivoting upon the conveyors; wherein there are multiple elongated light sources disposed above one another between and in substantially parallel relation to the troughs.

18. A system for hydroponic farming, the system comprising; two complementary conveyors disposed upon opposing sides of a plurality of elongated troughs, wherein the conveyors are arranged in a serpentine loop with multiple vertical peaks with substantially parallel vertical travel paths and the toughs are coupled to and capable of pivoting upon the conveyors; wherein the troughs have a substantially annular cross-section having a hollow interior and open ends, there are multiple elongated light sources disposed above one another between and in substantially parallel relation to the troughs, and the troughs have apertures disposed upon the dorsal faces thereof sized and shaped for hydroponically growing plants therein.
